(19) United States
(12) Patent Application Publication
(10) Pub. No.: US 2024/0307986 A1
(43) Pub. Date: Sep. 19, 2024

(54) METHOD FOR THE HARD FINE MACHINING OF TEETH OR OF A PROFILE OF A WORKPIECE

(71) Applicant: KAPP NILES GMBH & CO. KG, Coburg (DE)

(72) Inventors: Christopher GÖBEL, Ahorn (DE); Philip GEILERT, Ahorn (DE); Achim STEGNER, Coburg (DE)

(21) Appl. No.: 18/279,666

(22) PCT Filed: Mar. 19, 2022
(86) PCT No.: PCT/EP2022/057260

§ 371 Date: Aug. 31, 2023

(30) Foreign Application Priority Data
Mar. 29, 2021 (DE) 10 2021 107 885.7

(51) Int. Cl. B23F 1/02

(52) U.S. Cl. CPC B23F 1/02

(57) ABSTRACT

A method for hard fine machining of teeth or a profile of a workpiece by a hard fine machining tool in a hard fine machining machine. The workpiece is clamped on a spindle and is machined by the hard fine machining tool. During or after the machining of the workpiece, at least one signal is captured by at least one sensor or a machine controller and is stored in the machine controller. In the machine controller, the measured signal or at least one variable derived therefrom is compared with stored reference data so as to check whether the measured signal or the at least one variable derived therefrom lies within a predefined tolerance. If the measured signal or the at least one variable derived therefrom lies at least partly outside the predefined tolerance, the workpiece is measured by an additional measuring device after the machining of the workpiece.

The invention relates to a method for the hard fine machining of a toothing or a profile of a workpiece by means of a hard fine machining tool in a hard fine machining machine, wherein the workpiece is clamped on a workpiece spindle and is machined by means of the hard fine machining tool.

Hard finishing, especially in the form of grinding, is common in the manufacture of gears and is also of particular importance in the use of gears in electromobility. Here, as elsewhere, special care must be taken to ensure that the gearing produced meets high quality standards. High quality is characterised in particular by the fact that only a low level of noise is generated when the gearing is in operation.

Accordingly, it is essential that a sufficient inspection of the grinding result is carried out, i.e. the finished gears must be inspected at least spot-checked with regard to the quality of the ground gearing.

On the other hand, there is the demand to be able to carry out the manufacturing process as quickly as possible and thus at low cost.

The invention is based on the object of further developing a generic process in such a way that it is possible to ensure a high level of inspection of manufactured workpieces, while at the same time working as economically as possible.

The solution to this problem by the invention provides that during or after the machining of the workpiece in the hard fine machining machine at least one signal is measured by means of at least one sensor or a machine controller and is stored in the machine controller, wherein a comparison of the measured signal or at least one variable derived therefrom with stored reference data (or limit data or limit values of relevant parameters) takes place in the machine controller in such a way that it is checked whether the measured signal or the at least one variable derived therefrom lies within a predefined tolerance (i.e. within specified limits or thresholds, which may also include a safety margin that takes into account scatter), and wherein, in the event that the measured signal or the at least one variable derived therefrom lies at least partially outside the predefined tolerance, the workpiece is measured by means of an additional measuring device after the machining of the workpiece.

It should be noted that the term machine controller is to be understood in such a way that this is not necessarily a data processing system integrated into the machine, but a separate data processing device (e.g. an industrial PC) can also be used for the purpose mentioned.

Accordingly, a quick measurement can be carried out directly during the clamping of the workpiece on the workpiece spindle in the machine-in particular already during grinding—which provides a rough overview of the achieved quality level. If it is determined that certain tolerance limits have been exceeded, the workpiece in question is taken to a downstream inspection. The vibration during the grinding of the toothing can be considered as a signal to be recorded; this can be recorded by a sound or acceleration sensor. Likewise, recorded currents and/or speeds of the tool spindle and/or workpiece spindle can be taken into account here, which are recorded in the machine control.

The measuring on the additional measuring device can thereby be carried out within the hard finishing machine. In particular, it is envisaged that the measurement on the additional measuring device takes place in the state of the workpiece clamped on the workpiece spindle. The measurement can be carried out by means of a machine's own gear measuring device. In particular, the measurement can be carried out by means of a machine's own sensor with which the alignment of the workpiece with respect to the toothing or profile to be machined is carried out (i.e. with the alignment sensor).

Measuring on the additional measuring device can also be carried out outside the hard finishing machine.

There are various possibilities with regard to the measuring process: The measurement can be carried out by means of a tactile probe (in this case, the hard-finished (ground) surface of the workpiece is examined). It can also be carried out by means of a non-contact sensor, in particular by means of an inductive, capacitive or optical sensor.

The measurement can also be carried out on a single flank rolling measuring device; the single flank rolling measuring device can in particular detect rotational errors during the rotation of the workpiece.

The measurement can also be carried out on a gear measuring machine, whereby the measurement is carried out over a complete workpiece revolution. A particularly preferred embodiment provides that the measured surface of the workpieces is analysed in such a way that waviness is determined in the form of amplitudes above the order (see below: FFT analysis; alternatively also e.g. via a compensation sine function). This can be done, for example, by an all-tooth measurement of a gear.

Another possibility is that the measurement takes place on a transmission test bench, where the vibration generation of the workpiece under operating conditions is recorded. In this case, a signal related to the vibration generation can be recorded in the transmission test bench (for example, recorded by the emitted body or airborne sound by means of a sound or acceleration sensor).

A particularly preferred embodiment provides that an analysis is carried out for the signal recorded by means of the sensor or with the machine controller or for the signal recorded in the transmission test bench, which determines the amplitude of the signal, in particular of an oscillation, above order (modal analysis). The amplitude of the oscillation above the order is preferably determined by performing a Fast Fourier Transform (FFT).

The hard fine machining tool is in particular a grinding tool and especially preferably a grinding worm.

The proposed concept is therefore based on a two-stage measuring procedure for checking the quality of hard fine machining. The measurement, especially in the clamping of the workpiece in the machine, can be carried out with sensors (e.g. with acceleration sensors) or with signals from the machine controller, which already provide a rough orientation as to whether the required tolerance band was adhered to during machining. If this measurement shows that the tolerance band has been exceeded, a more precise re-measurement of the workpiece is carried out in a downstream measuring device, which can in particular also be arranged outside the hard fine machining machine. In particular, a gear test bench can be considered here, where the gear can be tested under the conditions that will be found in later operation.

The described procedure effectively monitors the hard fine machining process and detects faulty machining at an early stage.

The figures show an example of an embodiment of the invention.

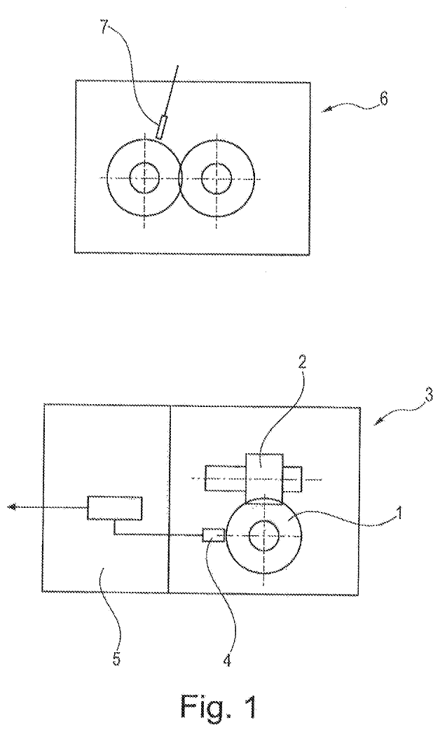

FIG. 1 schematically shows a grinding machine in which a gear wheel is ground, as well as a downstream measuring device for measuring or testing the ground gear wheel,

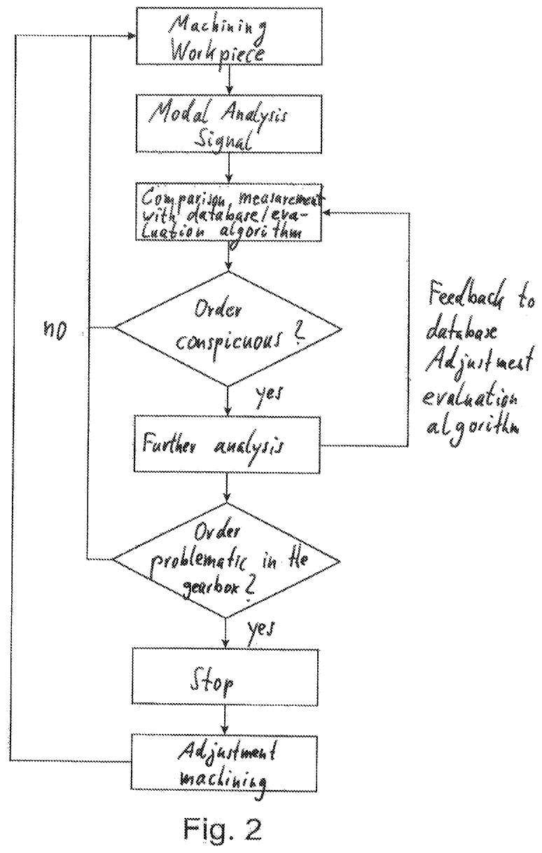

FIG. 2 shows a flow chart for machining and testing a workpiece,

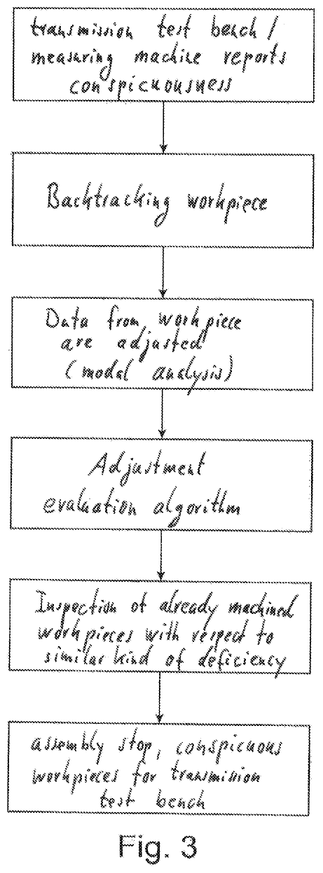

FIG. 3 shows another flow chart for the inspection of a workpiece,

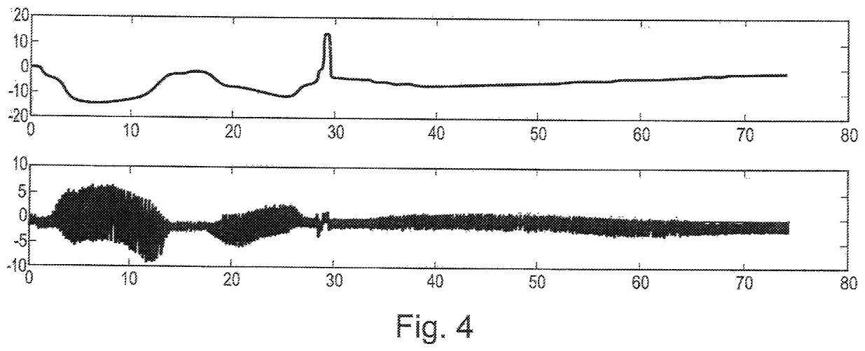

FIG. 4 shows recorded sensor signals in the time domain,

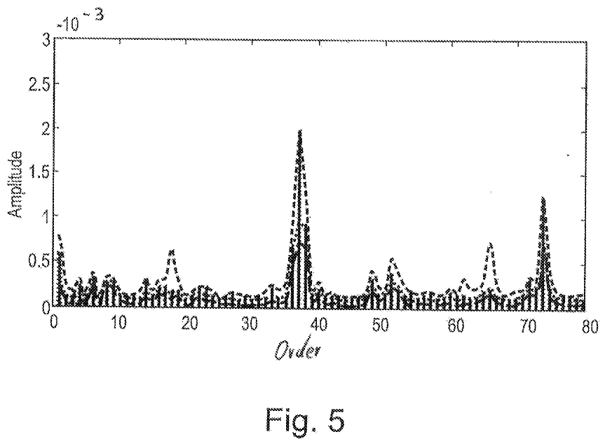

FIG. 5 shows the result of an order analysis carried out for the signal according to FIG. 4, which was obtained by a Fast Fourier Transform (FFT),

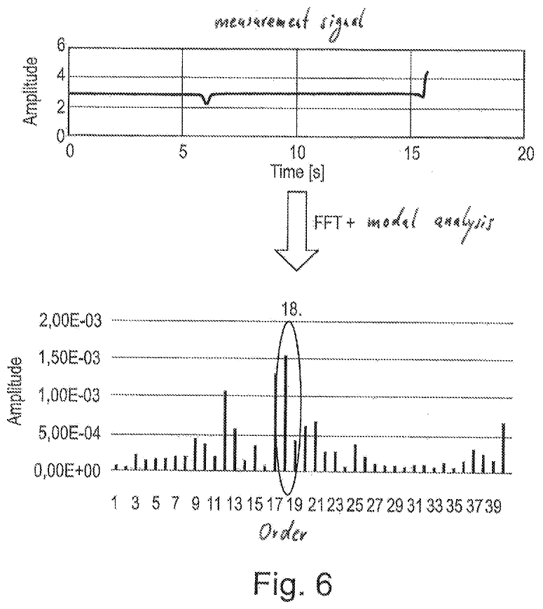

FIG. 6 shows the transition from the measured time signal to the order analysis, whereby here, as an example, the 18th order of the oscillation has a particularly high amplitude,

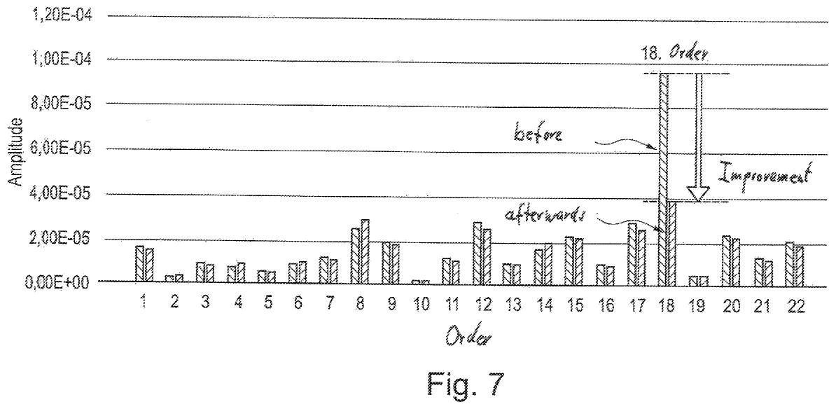

FIG. 7 shows an order analysis after changing the grinding process, whereby the amplitude of the 18th order could be reduced, and

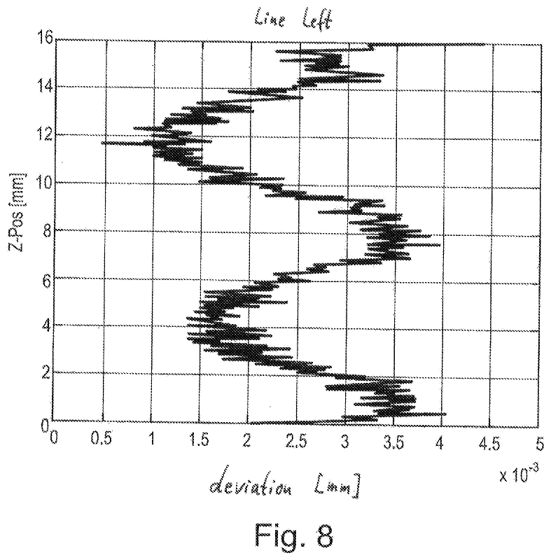

FIG. 8 shows the deviation of a flank line of a toothing from the ideal form over the tooth height recorded with a measuring probe.

FIG. 1 schematically shows a hard fine machining machine 3 in the form of a grinding machine in which a clamped workpiece 1 is machined by means of a hard fine machining tool in the form of a grinding worm 2. In the machine 3, adjacent to the ground toothing of the workpiece 1, a sensor 4 is arranged with which a measurement can be made. This can be the measurement of the ground toothing, but also, for example, the vibration recorded during grinding. Similarly, it can be a matter of recording an operating parameter of the machine, such as in particular the current or power consumption of the grinding spindle.

The machine 3 has a machine controller 5 in which, among other things, measurement data from the sensor 4 can be processed. As already explained above, the machine controller in this case also means an additional data processing system (e.g. an industrial PC) that is connected to the machine 3.

Downstream of or separate from the machine 3 is a further measuring device 6 in the form of a gear test bench. In the measuring device 6, a ground workpiece 1 can be examined under conditions that correspond to the subsequent application. The measuring device 6 has a (body or air) sound sensor 7 with which signals can be detected as emitted by the workpiece 1 during operation in the measuring device. It should be noted that the sensor 7 can also be any other type of sensor with which the vibration behaviour of the workpiece 1 can be detected.

In general, a measurement is made via the sensor 4 while the workpiece 1 is still being clamped on the workpiece spindle in the machine 3 during or after the grinding of the workpiece 1, with which at least parts of the machined surface of the workpiece 1 are measured or a machine parameter (operating parameter) is measured during grinding. The measurement data supplied by the sensor 4 are stored in the machine controller 5. Reference data is also stored here, on the basis of which a comparison is made as to whether the measured values are within a specified tolerance. If this is the case, the production process is continued unchanged for further workpieces.

However, if the measured data are at least partially outside the specified tolerance, the ground surface of the workpiece 1 is measured or parameters that occur during operation of the gearwheel are measured on the further measuring device 6. Since the subsequent use of the workpiece can preferably be simulated here, the measurement carried out here has a higher informative value and can determine whether it is a good part.

The design of the proposed concept can be varied or supplemented by a variety of other aspects. The following should be noted:

In the majority of cases, noisy gearing is only noticed on the gear test bench. The resulting costs (especially disassembly, possibly sorting out the entire batch of workpieces) are very high. One possibility to detect noisy gears is to carry out an all-tooth measurement on a measuring machine (possibly only for some measuring teeth). The flank, the profile and the pitch can be measured. The individual flanks and lines can be subjected to a downstream calculation (modal analysis) after a suitable sequence, so that waviness on the toothing can be assessed. Whether these determined wavinesses then also lead to excessive noise development in the gearbox, however, is not guaranteed.

The known methods have in common that the measurement takes place outside the grinding machine and that sometimes a relatively long period of time elapses before the result is available. This means that there is a risk that, in the event of a systematic error, workpieces will continue to be manufactured over a longer period of time, even though they might not meet the requirements with regard to waviness.

The elimination of the conspicuous waviness requires an intervention in the machining process and subsequently another run through the gear test bench or an all-tooth measurement in order to be able to assess the effectiveness of the improvement measure.

Thus, no direct coupling of process signals to the measured waviness is established with the previously known methods.

The following possible error case can be mentioned for generative grinding: Due to the dressing of the grinding worm, the worm diameter is continuously reduced. If the same cutting speed is then used, the speed of the tool axis and consequently also that of the tool axis changes accordingly. Thus the machine can run into an “unfavourable” speed ratio (e.g. into a resonance of the machine, i.e. an integer vibration is impressed on the workpiece). As a result, individual or all parts ground with these settings become noisy. If by chance a workpiece of this batch is “all-tooth measured”, the error can possibly be detected and the machining stopped. If no part is measured or not all workpieces of the batch are conspicuous, all “problem parts” are installed in the gearbox. Defects that are not systematic (e.g. due to the raw part) cannot be detected at all or only randomly with previously known methods.

The following error case can be mentioned for profile grinding: In profile grinding, the grinding wheel wears continuously during finishing. This results in pitch deviations between the individual ground gaps. Therefore, discontinuous pitching is used during finishing so that the pitch jumps are evenly distributed over the circumference. These pitch jumps can cause noise differently depending on their distribution in the gear. In contrast to generative grinding, the wear of the grinding wheel is considered when monitoring the process signals (for example, the reduction of the average value of the spindle power per stroke (here it must be taken into account that, as a rule, the spindle power drops initially due to a resetting of the bonds of the grinding wheel and then the spindle power increases due to a flattening and blunting of the individual abrasive grains before individual grains break out and the spindle power drops again)). This deviation belongs to the low-frequency deviations and can be detected by comparing the alignment signals before and after machining. A balancing between the strategy of discontinuously distributed finishing strokes and the pitch measurement is also possible.

The aim is therefore to reliably monitor the machined workpiece for noise irregularities without first having to measure the workpiece on the gear test bench or on an external measuring machine. Accelerometers and other standard machine sensors (probes, internal control signals) can be used for this purpose.

Likewise, the noise test stand can also work directly in interlinked operation with the machine, at which a 100 percent check of the components with regard to noise is guaranteed. Alternatively, workpieces that are above a limit value or within a defined interval can be automatically transferred to the interlinked noise test stand (additional measuring device). According to one embodiment, the measurement results of the test bench flow directly back into the grinding machine and compare these results with the key figures of the grinding process, thus enabling optimisation of the process or algorithm.

The grinding machine advantageously communicates with the gear test bench, the single flank rolling test device and/or the gear measuring machine with regard to noise conspicuities.

Using part tracing and a database concept, workpieces that have already been processed can be subsequently examined for previously unknown noise effects.

The general aim is to achieve (inline) 100-percent monitoring of the generative or profile grinding process for the prediction of gear wheels with noise problems for vehicle transmissions, especially for electric drives. The measurement and evaluation of selected signals play a special role here. The processing of the measured signals to characteristic values can be provided, which are related in particular to the workpiece rotation during machining (i.e. a modal analysis is carried out). The characteristic values can be used to form a noise index per workpiece, which is used to evaluate the noise conspicuity.

If noise is noticeable, the tooth flanks and profiles are measured and evaluated in the additional measuring device after machining for validation. This can be the machine's own gear measuring device (e.g. in the form of a measuring probe). For example, the pitch can be measured and evaluated with the machine's alignment sensor. This is particularly relevant for profile grinding, as pitch jumps can occur here due to wear of the grinding wheel during finishing.

In addition to the gear test bench already mentioned, a single flank rolling test can alternatively be carried out in the further measuring device. Alternatively, measurement with a gear measuring machine is possible. Another alternative is a measurement on an end-of-line test rig.

The proposed procedure can be related or reduced to specific workpieces. The selection of workpieces can be oriented to the production process, for example, if the first or the last workpiece between two dressing cycles is used for closer inspection.

The triggering of the measurement in the further measuring device can be made dependent on special circumstances. In particular, the signal recorded with the sensor 4 can be evaluated and a decision can then be made on this basis as to whether a subsequent measurement should take place. In particular, the evaluation of the recorded time signal via an oscillation analysis can be considered here, in which the amplitudes of the orders of the oscillation are considered (in particular determined by means of an FFT). If predetermined maximum amplitudes are exceeded for the respective orders of the oscillation, measurement in the further measuring device 6 can then be triggered.

The same applies if a geometric value is measured that can provide information about the quality of the ground gearing.

Specific messages about irregularities (e.g. wobbling of the grinding worm) can also be output to the machine operator.

If the tolerance or limit value is exceeded, a warning can be issued to the machine operator, the workpiece can be discharged for further inspection, the workpiece can be discharged as a NOK (“not OK”) part or machining can be stopped after a number of predefined exceedances.

Data exchange can be provided between the machine 3 and the further measuring device 6. Both automatic and manual transmission of the data can be provided.

Furthermore, an adjustment of the action limits in case of exceeding the tolerance or limit value for a production lot can be provided by feedback with the further measuring device (gear test bench or gear measuring machine).

Characteristic values or a noise index can be stored in relation to the workpiece, which makes improved part tracing possible if necessary.

A detection of noise-causing deviations thus becomes possible.

There are two scenarios that can occur:

In a first scenario, a conspicuous order (or several) provided via the modal analysis in the grinding machine is detected during machining.

In a second scenario, a conspicuous order (or several) is detected in the downstream assessment in the further measuring device (for example gear test bench or gear measuring machine).

In both cases, similar mechanisms take effect, as illustrated in FIG. 2 in the form of a flow chart. However, the illustration given here concerns the first scenario first.

For the second scenario, reference is made to FIG. 3.

A conspicuous order is reported in the transmission test bench 6 (or from the measuring machine). The associated machining process is determined via part tracing (for example by means of RFID or another code on the workpiece). The orders from the external measurement are compared with the modal analysis in the grinding machine.

Positive results (no abnormalities) can also be reported back to the machine from the external measuring equipment, such as the transmission test bench.

The following should be noted with regard to the individual points of the scenarios:

The measurement method for troubleshooting or optimising the machining process can be realised as follows: Unfavourable speed ratios can be responsible for conspicuous orderings. Based on the available information about the individual machine components and process or operating parameters, the orders in the transmission test bench can be calculated back to the individual machine components (and their rotational speeds) and the corresponding rotational speeds can be adjusted.

Intrinsic resonances of the machine can also lead to conspicuous order; with the help of known condition monitoring tools in the machine, adjustments and improvements can be carried out and changes in individual components can be detected.

Another possibility is that a probe (for example from the measuring device) or a non-contact sensor (for example an inductive sensor, which is also used for alignment) checks the workpiece on a predefined test collar and thus draws attention to errors, such as concentricity errors.

The suggestions for optimising the machining process can be both project-specific (workpiece) and machine-specific.

Regarding the adaptation of the limits for the monitoring or optimisation of the evaluation algorithm, the following should be noted:

Due to the peculiarities of each gear, there is no universal limit curve that is valid for all types of workpieces. Each workpiece type or machining process is taught individually. At the beginning of the learning phase, the limits can be preset (for example, according to VDI/VDE 2612 Sheet 1).

The resulting limits can be global for the machine as well as workpiece-specific (project-related) and then machine-independent. A combination of machine-specific and workpiece-specific limits is also possible.

The information whether an order is conspicuous can come directly from the gear grinding machine (for example by means of the probe), from the single flank rolling test device, from the gear measuring machine or from the transmission test bench (highest weighting).

In this case, the grinding process is to be monitored with regard to error patterns that are conspicuous for noise. For this purpose, the process signals (actual current value, power, actual speed value of the workpiece and tool axis) and acceleration sensors (placed on the workpiece and tool axis) are measured and evaluated.

The evaluation of the process signals is preferably carried out with the help of a modal analysis. The signals recorded in the time domain are transferred into the frequency domain, preferably by means of the Fast Fourier Transform (FFT), and then the frequencies are converted into orders, related to the workpiece rotation, with the help of the measured machining speed.

In this respect, reference is made to the illustrations in FIGS. 4 to 8.

FIG. 4 shows sensor signals in the time domain, which were then transferred to the frequency domain by FFT, as shown in FIG. 5, and show which amplitude is present at which order of the oscillation. Thus, the “harmonics” are determined from the periodic time signal, whereby the amplitude of the individual frequency components of the detected periodic signal are determined via the order.

The same applies to the representation in FIG. 6, where the measurement signal is shown at the top, from which the modal analysis shown below was derived. Here it can be seen that the 18th order is conspicuously large. If measures are taken in the grinding process, an improvement can be achieved, as shown in FIG. 7.

FIG. 8 illustrates the measurement of anomalies with a probe directly in the grinding machine. The superimposed vibration to be detected can apply a detrimental fine waviness to the tooth flank, which can lead to noise in the use of the gearing; this is particularly disadvantageous in the field of electromobility.

As an alternative to using a Fast Fourier Transform (FFT), a wavelet transform or the use of a balancing sine can also be provided.

The (tolerance) limits up to which the order is conspicuous can be set explicitly or on the basis of previous measurements. Furthermore, it is possible that the limits can be adjusted by the machine operator through the information feedback from the further measuring device (transmission test bench or gear measuring machine).

If a “conspicuous” order is detected in the machining process, the machining of the current workpiece is completed and a measurement of the ground gearing is initiated.

If no conspicuous order can be detected via the gear measurement, machining can be continued and/or the workpiece in question can be examined more extensively externally.

If there is a conspicuous order, the workpiece is discharged and further steps for examination are initiated. If x parts (x defined by the user or customer) are conspicuous in succession, further processing is automatically interrupted. Further processing must then be released by a machine operator.

Further examinations can also be provided, whereby the workpiece is examined on the gear measuring machine with regard to waviness, or whereby the workpiece is examined on a single flank rolling test bench, or whereby the workpiece is installed in the gear and examined via the EOL test bench.

All downstream processes can communicate with the grinding machine either automatically or via a manual interface.

The information returned from the downstream measurements can be assigned to the grinding process (allowing part tracing) and influence the limits of the process monitoring modal analyses.

The results of the EOL test bench preferably have the highest priority in influencing the limits.

If the anomalies are confirmed (or due to the first anomalies in the machine), an optimisation of the machining process can be aimed at.

Examples of such optimisation of the machining process are, in particular, the adjustment of the machining speed, the number of threads of the worm and the feed rate during grinding, the modification of the unbalance limits and concentricity optimisation.

### LIST OF REFERENCES

1 Workpiece
2 Hard fine machining tool (grinding worm)
3 Hard fine machining machine
4 Sensor
5 Machine controller
6 Additional measuring device
7 Sound sensor

1-15. (canceled)

16. A method for the hard fine machining of a toothing or a profile of a workpiece by means of a hard fine machining tool in a hard fine machining machine, wherein the workpiece is clamped on a workpiece spindle and is machined by means of the hard fine machining tool, wherein during or after the machining of the workpiece in the hard fine machining machine at least one signal is measured by means of at least one sensor or a machine controller and is stored in the machine controller,
wherein a comparison of the measured signal or at least one variable derived therefrom with stored reference data takes place in the machine controller in such a way that it is checked whether the measured signal or the at least one variable derived therefrom lies within a predefined tolerance, and
wherein, in the event that the measured signal or the at least one variable derived therefrom lies at least partially outside the predefined tolerance, the workpiece is measured by means of an additional measuring device after the machining of the workpiece.

17. The method according to claim 16, wherein the measuring is carried out on the additional measuring device within the hard finishing machine.

18. The method according to claim 17, wherein the measuring on the additional measuring device takes place in the state of the workpiece clamped on the workpiece spindle.

19. The method according to claim 17, wherein the measuring is carried out by means of a machine's own gear measuring device.

20. The method according to claim 17, wherein the measuring is carried out by means of a machine's own sensor with which the alignment of the workpiece with respect to the toothing or profile to be machined is carried out.

21. The method according to claim 16, wherein the measuring is carried out on the additional measuring device outside the hard finishing machine.

22. The method according to claim 17, wherein the measurement is carried out by means of a tactile measuring sensor.

23. The method according to claim 17, wherein the measurement is carried out by means of a contactless sensor, in particular by means of an inductive, a capacitive or an optical sensor.

24. The method according to claim 17, wherein the measuring is carried out on a single flank rolling measuring device, wherein the single flank rolling measuring device detects in particular rotational errors during the rotation of the workpiece.

25. The method according to claim 21, wherein the measuring is carried out on a gear measuring machine, wherein the measuring is carried out over one complete workpiece revolution.

26. The method according to claim 21, wherein the measurement is carried out on a transmission test bench, wherein in the same the vibration generation of the workpiece is recorded under operating conditions.

27. The method according to claim 26, wherein a signal associated with vibration generation is detected in the transmission test rig.

28. The method according to claim 16, wherein an analysis is carried out for the signal recorded by means of the sensor or with the machine controller or for the signal recorded in the transmission test bench, which analysis determines the amplitude of the signal, in particular of an oscillation, above order.

29. The method according to claim 28, wherein the amplitude of the oscillation above order is determined by performing a Fast Fourier Transform.

30. The method according to claim 16, wherein the hard fine machining tool is a grinding tool, in particular a grinding worm.
